(19) United States
(12) Patent Application Publication
(10) Pub. No.: US 2012/0031145 A1
(43) Pub. Date: Feb. 9, 2012

(54) Method of fabricating decoratively-cracked glass vessels

(75) Inventor: Michael Arnold Albert Kramer, Mexico City (MX)

(73) Assignee: Grupo Pavisa, S.A. de C.V.

(21) Appl. No.: 13/136,460

(22) Filed: Aug. 2, 2011

Related U.S. Application Data
(60) Provisional application No. 61/571,647, filed on Jul. 2, 2011.

(30) Foreign Application Priority Data
Aug. 4, 2010 (MX) MX/E/2010/048025

(51) Int. Cl. C03B 31/00; C03B 9/14

(52) U.S. Cl. 65/64; 65/72; 65/111

(57) ABSTRACT

A method of fabricating a decoratively-cracked glass vessel includes gathering a gob of molten glass and depositing the molten-glass gob into a pre-form mold. A quantity of gas is injected into the pre-form mold in order to form the gob into a pre-form vessel having at least one pre-form wall defining a pre-form vessel exterior surface and a pre-form vessel interior surface defining a pre-form cavity. The self-supporting, but still hot, pre-form vessel is removed from the pre-form mold and a surface of the pre-form vessel is rapidly cooled in order to crack in the cooled surface. The heated pre-form vessel is situated within a finish mold and a quantity of gas is injected into the pre-form cavity in order to seal cracks and form the pre-form vessel into a finished vessel having at least one finished vessel wall defining finished vessel interior and exterior surfaces between which cracks are visible.

Priority based on Provisional Application Ser. No. 61/571,647 filed Jul. 2, 2011, and entitled “METHOD OF FABRICATING DECORATIVELY-CRACKED GLASS OBJECTS” is claimed. Priority is also claimed in Mexican Patent Aplication Folio No. MX/E/2010/048025 filed Aug. 4, 2010 and entitled ELABORACION DE BOTELLAS DE VIDRIO Y CRISTAL POR MEDIO DE LA TECNICA DE CRAQUELADO. The entirety of the disclosures of each of the previous applications, including the drawings, is incorporated herein by reference as if set forth fully in the present application.

### BACKGROUND

The formation of glass into useful and artistic objects dates to at least the 4^{th} Century BCE. Among the established techniques for forming glass are flow-molding, press-molding and hand-blowing. Hand-blown glass objects are admired for the artistry and skill required to produce them, and the uniqueness of each piece so produced. One effect traditionally produced by glass-blowing artisans is the inclusion of decorative cracks in finished products. The inclusion of such features signifies artistry, skill and uniqueness. However, the very nature of the hand-blowing process renders hand-blown pieces expensive and impractical for use as containers for all but the highest-end products such as fine perfumes and select alcoholic beverages.

Contrasting with the artistry associated with hand-blown glass objects is the rapid mass production of strictly utilitarian objects such as window panes and beverage bottles. Among the goals of manufacturing vessels such as drinking glasses and beverage bottles are rapid reproducibility and uniformity of appearance among units. Of particular importance is uniformity among units in physical dimensions such opening shape and size in order to facilitate the use of standardized lids, plugs or caps as closures. Accordingly, in the modern era, glass vessels are largely produced by strictly-controlled automated hot pressing and blowing processes. Such processes have the advantage of being relatively inexpensive and invariant, but result in products lacking uniqueness and artistry.

Accordingly, a need exists for a method of incorporating, within a glass object, and particularly a glass vessel, the unique feature of decorative cracks in a manner that facilitates ready and reliable reproducibility of predetermined physical dimensions.

### SUMMARY

Implementations of the present invention are generally directed to a method of mass-producing consistently-dimensioned cracked-glass vessels incorporating decorative cracks while maintaining structural integrity. Although not so limited in scope, among the glass vessels of particular interest are drinking glasses, cups, bowls, decanters, vases, and selectively closeable bottles.

In accordance with an illustratively implemented method, an initial gob of molten glass is gathered. In a typical version, the molten-glass gob is removed from a glass furnace by gathering it about a distal end of an elongated gathering implement such as a rod, tube or gathering iron, by way of example. The molten-glass gob is introduced into a pre-form mold into which—in one implementation—a quantity of gas, such as air, by way of non-limiting example, is injected in order to form the gob into a pre-form vessel having at least one pre-form vessel wall defining a pre-form vessel exterior surface and a pre-form vessel interior surface defining a pre-form vessel cavity. The quantity of gas blown into the pre-form mold depends, in part, on the desired wall and base thicknesses of the vessel being formed. In various illustrative implementations, depending on the size and shape of the vessel being formed, the pre-form vessel remains in the pre-form mold for a period of between 2 and 5 seconds before it is removed and transferred for subsequent processing.

In one version, when the pre-form vessel is sufficiently cool and “self-supporting” to retain its basic shape, it is removed, while still hot, from the pre-form mold, and a surface of the same is exposed to a fluid that is sufficiently cool, relative to the pre-form vessel, that cracks are formed along the surface exposed to the fluid. In any particular implementation, an appropriate temperature differential between the pre-form vessel and the rapid-cooling fluid is a function of the glass type, pre-form vessel wall thickness and the specific heat of the fluid in question. In each case, the aforesaid temperature differential should be sufficiently large in magnitude to introduce the desired cracks, but not so large that the pre-form vessel experiences thermal shock that either shatters the pre-form vessel or introduces cracks too deep into the pre-form vessel wall. In some illustrative implementations, the fluid to which the pre-form vessel is exposed in order to crack it is a liquid, such as water. However, absent express limitations to the contrary in the appended claims, it is to be understood that the rapid-cooling fluid may be a liquid other than water or even a gas. In one illustrative version in which a liquid is used, a liquid temperature of 26-deg. Celsius is regarded as optimal. Additionally, in alternative versions, the surface of the pre-form vessel that is exposed to the rapid-cooling fluid is the exterior surface.

In a first illustrative version in which the desired crack effects have been introduced, the pre-form vessel is reheated such that the glass becomes sufficiently flowable that (i) cracks are sealed between the pre-form interior and exterior surfaces and (ii) the pre-form vessel can be reshaped. The reheated pre-form vessel is introduced into a finish mold. A quantity of gas is injected into the finish mold in order to form the pre-form vessel into a finished vessel having at least one finished vessel wall defining finished vessel interior and exterior surfaces between which cracks are visible and sealed. In a second illustrative version in which the desired crack effects have been introduced, the pre-form vessel is not reheated before finish molding. Instead, immediately after the introduction of cracks by exposure to a cooling fluid, the pre-form vessel is introduced into the finish mold where it is injected with air for a brief period of time (e.g., between 3 and 4 seconds). This finish molding step itself promotes the “sealing” of cracked areas internally from within the vessel, as long as the pre-form vessel is still sufficiently heated after cracking.

In some implementations, the pre-form and finish molds are actually the same physical mold which, when used in a “pre-forming” step is referred to as a “pre-form mold” and, when used in a “finish-molding” step is referred to as a “finish mold.” In fabricating a more complex glass vessel, such as a bottle including a neck, the use of physically distinct pre-form and finish molds facilitates intermediate shaping, thereby obviating logistical difficulties and diminished quality attendant to the use of a single mold at two different stages of the process in order to form of a shapeless gob into the final shape desired. Although the summation of the process to this point has implied molding in two stages, it will be generally appreciated that implementations prescribing more than two molding steps are also within the scope of the invention as defined in the claims. More specifically, even in implementations involving three or more molding steps, at least one such step (e.g., the first molding step) is regarded as a pre-forming step involving a pre-form mold, while at least one other step (i.e., the final molding step) is regarded as a finish molding step involving a finish mold. In at least one implementation described later in the present specification, a finish mold is used in intermediate and final molding steps.

Irrespective of whether the pre-form vessel is re-heated prior to finish molding, alternative implementations of the process prescribe heating of the cracked and finish-molded vessel or “finished vessel.” More specifically, the finished vessel is removed from the finish mold and permitted to cool for a brief period of time, typically between 2 and 4 seconds, for example. The finished vessel is then heated in order to seal the cracks on the exterior surface of the vessel while taking care not to re-melt the glass and perceptibly deform the shape of the finished vessel. In an illustrative implementation, the finished vessel is heated by a burner system in which burners torch the area of the vessel cracked by exposure to the cooling fluid. In various versions, the cracked regions are torched for between 3 and 6 seconds. However, as with the other time ranges presented as examples, this latter range should not be regarded as limiting the scope of the inventive process absent express limitations to the contrary in the claims appended hereto.

In alternative implementations, apparatus controlled by a programmable computer are variously utilized in the performance one or more steps. For instance, the use of a computer-controlled pneumatic injector is particularly useful in ensuring that the quantity and pressure of gas injected into the mold is appropriate, precise and selectively tunable. Additionally, at least one multi-piece mold can be opened and closed by computer-controlled pneumatics, hydraulics or motor-actuated linkages. While human involvement is integral to the implementation of some versions, particularly at the gob-gathering, cracking and heating stages—where an artisan's vision and skill might be desired—in alternative versions, even one or more of the steps prior to introduction of the gob into either the pre-form mold, or the introduction of the pre-form vessel into the finish mold, is performed by computer-controlled apparatus.

Representative, non-limiting implementations are more completely described and depicted in the following detailed description and the accompanying drawings.

### BRIEF DESCRIPTION OF THE DRAWINGS

FIG. 1 depicts a gathered gob of molten glass being extracted from a glass furnace;

FIG. 2 shows the molten-glass gob of FIG. 1 being deposited into a vessel-defining pre-form mold;

FIG. 3A depicts the opened pre-form mold and the injection of gas to force the molten gob to assume a non-final shape defined by the pre-form mold, although the pre-form mold would not be open when gas is injected;

FIG. 3B shows the non-finally-shaped pre-form vessel after removal from the pre-form mold;

FIG. 3C depicts the non-finally-shaped pre-form vessel situated in an open finish mold;

FIG. 4 shows the finish mold of FIG. 3C in a closed position so that gas can be introduced to finalize the basic shape of the pre-form vessel of FIGS. 3A-3C;

FIG. 5 depicts the finish mold of FIGS. 3C and 4 in an open position with the finally-shaped pre-form vessel still disposed therein;

FIG. 5A illustrates the removal of the finally-shaped pre-form vessel of FIG. 5 from the finish mold for transfer to subsequent processing;

FIG. 5B shows the finally-shaped pre-form vessel of FIGS. 5 and 5A being at least partially immersed in a rapid-cooling fluid in order to introduce cracks in the pre-from vessel exterior surface;

FIG. 6 shows the cracked and finally-shaped pre-form vessel of FIG. 5B re-situated in the finish mold of FIGS. 3C, 4 and 5 so that the cracks can be sealed by the introduction of pressured gas into the interior of the pre-form vessel;

FIG. 7 depicts a finished vessel resulting from the crack-sealing step associated with FIG. 6;

FIG. 7A shows the finished vessel of FIG. 7 being heated to facilitate crack sealing from the exterior of the vessel;

FIG. 8A illustrates the formation of a glass gob into a non-finally shaped pre-form vessel in a pre-form mold, in much the same manner depicted in FIG. 3A;

FIG. 8B illustrates the removal of the non-finally-shaped pre-form vessel of FIG. 8A from the pre-form mold for transfer to subsequent processing;

FIG. 8C shows the non-finally-shaped pre-form vessel of FIGS. 8A and 8B being at least partially immersed in a rapid-cooling fluid in order to introduce cracks in the pre-from vessel exterior surface; and

FIG. 9 depicts how the cracked and non-finally-shaped pre-form vessel of FIG. 8C is reshaped into a finally-shaped finished vessel in a finish mold.

### DETAILED DESCRIPTION

The following description of methods of fabricating a glass vessel with decorative cracks is demonstrative in nature and is not intended to limit the invention or its application of uses. The various implementations, aspects, versions and embodiments described in the summary and detailed description are in the nature of non-limiting examples falling within the scope of the appended claims and do not serve to maximally define the scope of the claims.

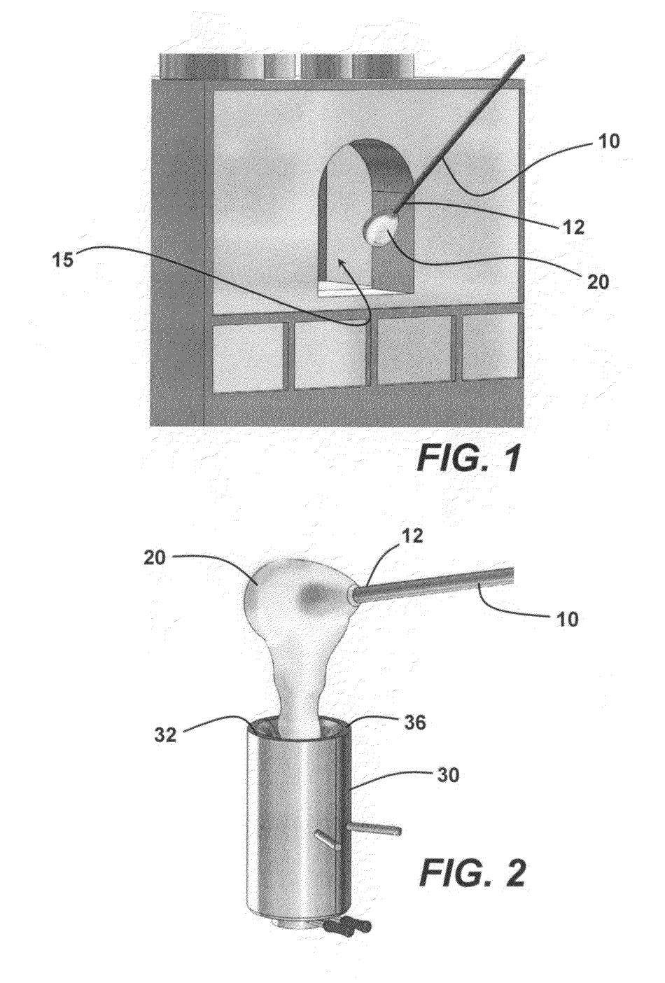

In conjunction with FIGS. 1 through 9, there are described alternative illustrative methods of fabricating a decoratively-cracked glass vessel. With initial reference to FIG. 1, a molten-glass gob 20 is gathered around the distal end 12 of an elongated gathering implement 10 and extracted from a furnace 15. The gathering implement 10 is manipulated in order to give the initial gob 20 a generally ellipsoidal shape.

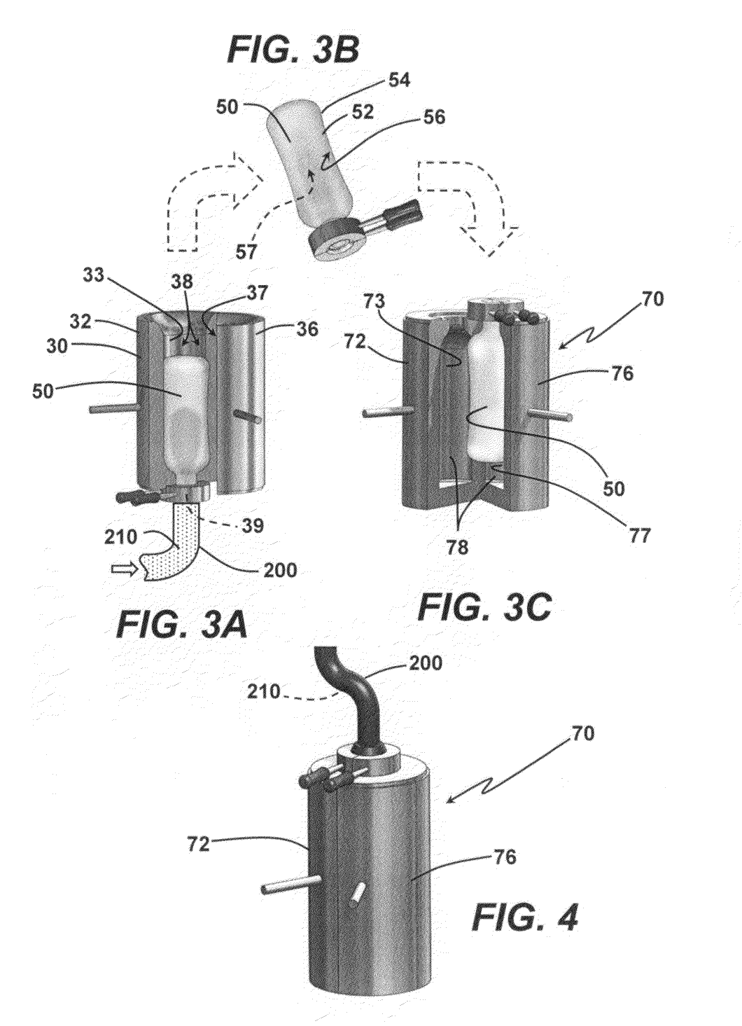

The illustrative implementations described with reference to FIGS. 1 through 9 prescribe multi-stage molding processes, each of which includes, as shown in FIG. 2, the introduction of the molten-glass gob 20 into a pre-form mold 30. With additional reference to FIG. 3A, the illustrative pre-form mold 30 first shown in FIG. 2 includes first and second mold portions 32 and 36 with, respectively, first and second interior walls 33 and 37. When the first and second mold portions 32 and 36—which are hingedly joined in the example depicted—are brought into mutual contact, the first and second interior walls 33 and 37 define an internal pre-shaping cavity 38. In the illustrative version depicted, the pre-shaping cavity 38 is configured to define a pre-form vessel 50.

With continued reference to FIGS. 2 and 3A, with the molten-glass gob 20 deposited in the pre-form mold 30, a pneumatic injector 200 injects a quantity of gas 210 into the pre-form mold 30 through an opening 39. The internal gas pressure is elevated sufficiently to form the gob 20 into a pre-form vessel 50. While the formation of the gob 20 into a pre-form vessel 50 is shown in FIG. 3A with the pre-form mold 30 depicted in an open position, this is only to facilitate explanation; it is to be understood that the introduction of gas 210 into the pre-form mold 30 actually occurs while the first and second mold portions 32 and 36 are in mutual contact (i.e., while the pre-form mold 30 is closed, as in FIG. 2).

When the pre-form vessel 50 is sufficiently cool and “self-supporting” to retain its basic shape, the pre-form mold 30 is opened and the pre-form vessel 50 is removed, as shown in, respectively, FIGS. 3A and 3B. The illustrative pre-form vessel 50 of FIG. 3B has a pre-form vessel wall 52 defining a pre-form vessel exterior surface 54 and a pre-form vessel interior surface 56 defining a pre-form vessel cavity 57. In a first illustrative version, described initially with reference to FIGS. 3A, 3B and 3C, the heated pre-form vessel 50 is transferred from the pre-form mold 30 to a finish mold 70. The illustrative finish mold 70 of FIG. 3C includes first and second mold pieces 72 and 76 having, respectively, first and second inside walls 73 and 77. When the first and second mold pieces 72 and 76 are urged into mutual contact to seal the finish mold 70, the first and second inside walls 73 and 77 define an internal finish-shaping cavity 78. As shown in FIG. 4, in a manner analogous to that associated with shaping in the pre-form mold 30, a quantity of gas 210 is injected into the finish mold 70, and into the pre-form vessel cavity 57, through a pneumatic injector 200 in order to impart to the pre-form vessel 50 its final basic shape.

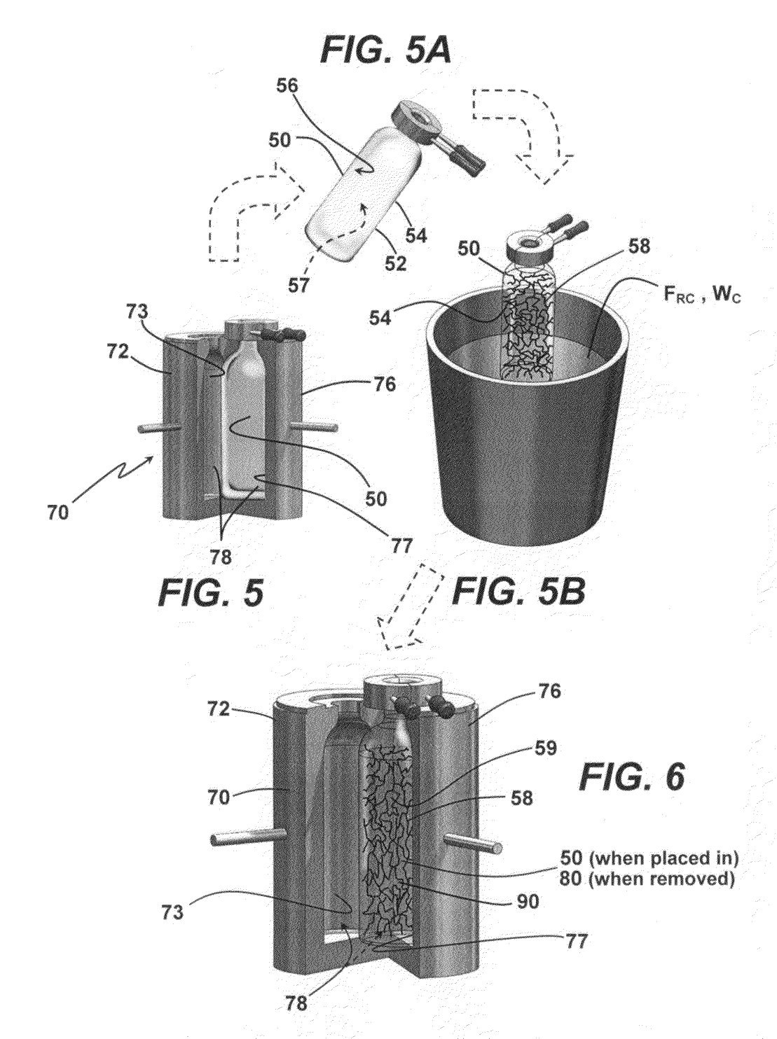

Referring to FIGS. 5 and 5A, after shaping in the finish mold 70, the finish mold 70 is opened and the pre-form vessel 50 is removed. Although the vessel has been given its final basic shape, it is, in accordance with the implementation presently under consideration, still regarded as a pre-form vessel 50 because, as explained below, it is subjected to subsequent processing within the finish mold 70.

With continued reference to FIGS. 5 and 5A, and additional reference to FIG. 5B, the aforementioned first version prescribes exposing at least one of the finally-shaped pre-form vessel exterior and interior surfaces 54 and 56 to a rapid-cooling fluid F_{RC} that is sufficiently cool relative to the pre-form vessel 50 that cracks 58 are formed along the surface exposed to the fluid F_{RC}. For illustrative, non-limiting purposes, FIG. 5B shows the still-hot pre-form vessel 50 of FIGS. 5 and 5A being immersed in a reservoir of cool water W_{C} in order to form cracks 58 in the pre-form vessel exterior surface 54. As stated in the summary, however, it will be appreciated that the rapid-coiling fluid F_{RC} need not be water, or even a liquid; a cold gas may be alternatively implemented as the fluid F_{RC}. It is also to be understood that, while the example of FIG. 5B shows the pre-form vessel exterior surface 54 being cracked, the pre-form vessel interior surface 56 could be cracked by introduction of fluid F_{RC} into the pre-form vessel cavity 57. However, experimentation has indicated that cracking from the exterior surface 54 less difficult and generally yields superior results. In various implementations, the cracks 58 extend through nearly the entire thickness of the pre-form wall 52.

With reference to FIG. 6, the now-cracked pre-form vessel 50 of FIG. 5B is, while heated, re-introduced into the finish mold 70. The finish mold 70 is then closed and gas 210 is injected in the manner shown in FIG. 4. Subjecting the perform vessel 50 to elevated internal gas pressure in this final “molding” step facilitates the “sealing” of cracks 58 from within the interior of the vessel. More specifically, while the cracks 58 remain visible, the elevated pressure exerted by the gas 210 within the pre-form vessel cavity 57 causes the movement (flow) of still-heated glass outwardly toward the pre-form vessel exterior surface 54 between “islands” 59 of glass defining the cracks 58. When the glass “flowably forced” into the cracks 58 from the vessel interior cools, it fuses and increases structural integrity, while maintaining the visibility of the cracks 58. It will be appreciated that this final “molding” step in the version currently under consideration is more in the nature of a crack-sealing step, as the pre-form vessel 50 will undergo little, if any, shape redefining at this stage.

After sealing in the finish mold 70, the pre-form vessel 50 has been transformed into what is regarded as a “finished vessel” It will be appreciated, particularly in implementations involving more than two “molding” stages, that the designation of a work-piece as either a “pre-form vessel” or a “finished vessel” can be somewhat arbitrary. This is particularly the case when, for example, a finish mold (e.g., finish mold 70) is used in more than one step since the final basic shape is imparted to the vessel prior to the final “molding” step. However, in an effort to lend a measure of clarity to the description, a vessel undergoing processing is regarded as a “pre-from vessel” up until the point that is treated for the last time in a mold. More specifically, upon introduction into a finish mold for the final time, a vessel is referred to as a “pre-form vessel” and, upon removal from that mold for the last time, it is regarded as a “finished vessel.”

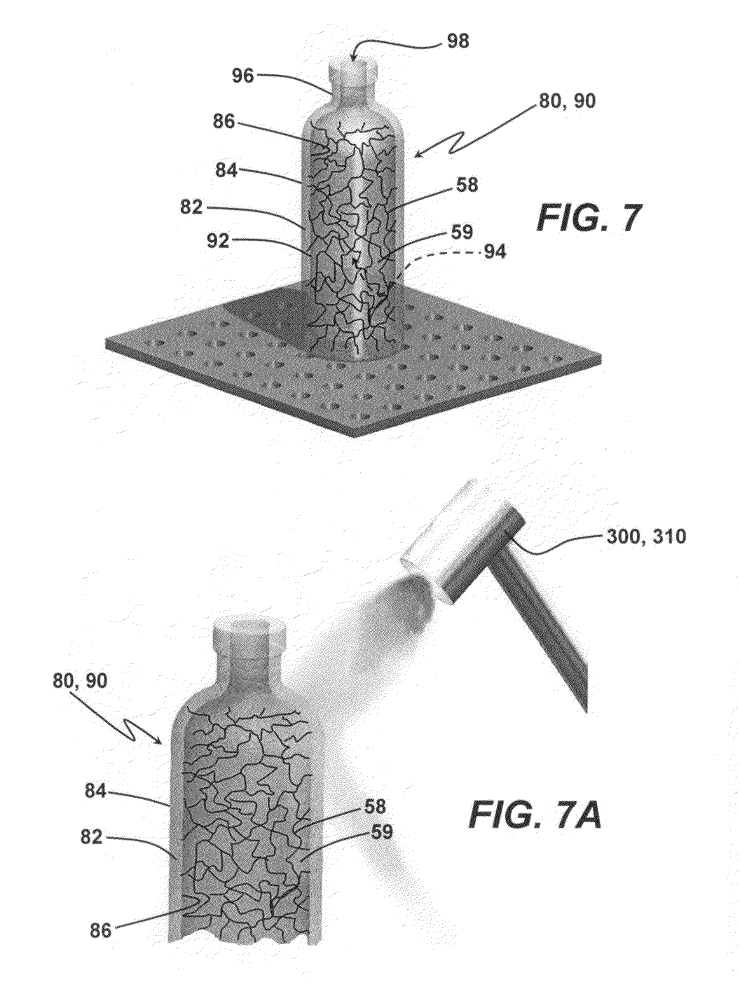

An example of a finished vessel 80 is shown in FIG. 7. The finished vessel 80 has at least one vessel wall 82 defining finished vessel exterior and interior surfaces 84 and 86 between which cracks 58 are visible and at least partially sealed.

Referring to FIG. 7A, in some versions, the finished vessel 80, after removal from the finish mold 70, is allowed to cool for a predetermined duration (e.g. between 2 and several seconds). The finished vessel 80 is then heated in order to seal the cracks 58 on the vessel exterior surface 84 while measures are taken not to re-melt the glass and perceptibly deform the shape of the finished vessel 80. In an illustrative implementation, the finished vessel 80 is heated by a burner system 300 in which one or more burners torch the area of the vessel 80 cracked by exposure to the cooling fluid F_{RC}. In FIG. 7A, the burner system 300 is represented by a torch 310 for purposes of non-limiting illustration.

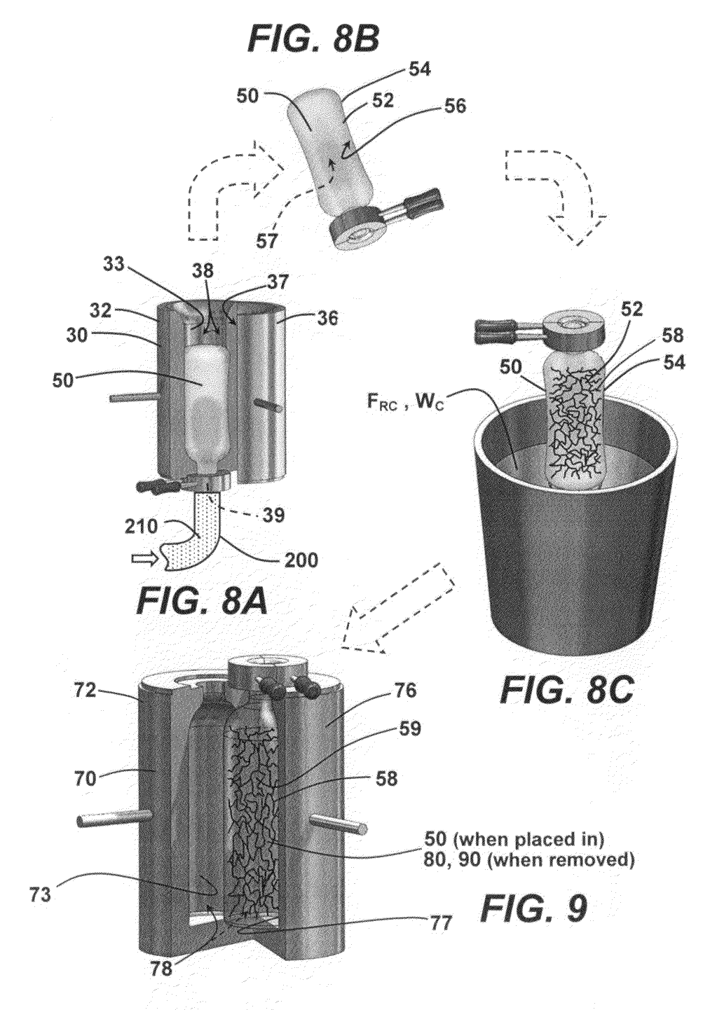

A second illustrative version tracks the initial steps of the first illustrative version described above in conjunction with FIGS. 1 through 3B. However, whereas the first illustration version calls for the pre-form vessel 50 to be transferred directly from a pre-form mold 30, in which it is given a non-final configuration, to a finish mold 70, in which it is given its final basic shape, the second version differs by prescribing intermediate cracking prior to final shaping. More specifically, and with initial reference to FIGS. 8A, 8B and 8C, at least one of the non-finally-shaped (or “intermediately-shaped”) pre-form vessel exterior and interior surfaces 54 and 56 is exposed to a rapid-cooling fluid F_{RC} that is sufficiently cool relative to the pre-form vessel 50 that cracks are formed along the surface exposed to the fluid F_{RC}. For illustrative, non-limiting purposes, FIG. 8C shows the still-hot pre-form vessel 50 of FIGS. 8A and 8B being immersed in a reservoir of cool water W_{C} in order to form cracks 58 in the pre-form vessel exterior surface 54.

Following the introduction of cracks 58 along at least one pre-form wall 52, in a first implementation in which the non-finally-shaped pre-form vessel 50 is cracked, the pre-form vessel 50 is reheated in order to (i) fuseably seal the cracks 58 under a continuous “skin” of glass between the pre-form interior and exterior surfaces 56 and 54 and (ii) render the pre-form vessel 50 sufficiently soft for additional shaping. It will be appreciated that the reheating of the pre-form vessel 50 involves a balance of mutually competitive objectives. In accordance with one set of objectives, the pre-form vessel 50 is heated sufficiently to facilitate “sealing over” of the cracks 58 and refined shaping. However, a second set of objectives indicates that the pre-form vessel 50 not be heated to such an extent that the cracks 58 are lost through complete re-fusion of glass through the entire thickness of the pre-form wall 52 or such that the pre-form vessel 50 loses too much of its shape. In a second implementation in which the non-finally-shaped pre-form vessel 50 is cracked, the vessel 50 is not re-heated prior to subsequent processing. It will be appreciated, however, that the pre-form vessel 50 must still be sufficiently hot for final shaping in general accordance with the steps described below. In illustrative cases in which the pre-form vessel 50 is reheated, it is introduced into a furnace, such as furnace 15 in FIG. 1, or heated by a burner 300 or torch 310, as shown in FIG. 7A. It will be appreciated that the method of re-heating is of no particular importance.

Irrespective of whether the cracks 58 are sealed over by re-heating, the cracked and non-finally-shaped pre-form vessel 50, while still sufficiently heated for shape refinement, is situated within a finish mold 70. As with the finish mold 70 of FIG. 3C, the illustrative finish mold 70 of FIG. 9 includes first and second mold pieces 72 and 76 having, respectively, first and second inside walls 73 and 77. When the first and second pieces 72 and 76 are urged into mutual contact, the first and second inside walls 73 and 77 define an internal finish-shaping cavity 78. As in FIG. 4, a quantity of gas 210 is injected into the finish mold through a pneumatic injector 200 in order to form the pre-form vessel 50 into a finished vessel 80. More specially, as indicated in FIGS. 8C and 9, the vessel is a non-finally-shaped pre-form vessel 50 when it is placed into the finish mold 70 and, when the vessel emerges from this final molding step, it is a finally-shaped finished vessel 80. As in the case of the first major implementation, a finished vessel 80 fabricated in accordance with the present implementation can be heated as shown in FIG. 7A, for example, in order to seal the cracks 58 on the vessel exterior surface 84.

As previously explained, alternative implementations involve the use of either (i) a single mold in temporarily separate “pre-forming” and “finish-molding” steps or (ii) two or more physically distinct molds in “pre-forming” and “finish-molding” steps. As a general observation, more intricate final products call for molding in at least two stages with at least two physically distinct molds. For instance, while the formation of a vessel such as a drinking cup might be pre-formed and finish molded in a single physical mold, a vessel such as a bottle might call for physically distinct pre-form and a finish molds. The illustrative finished vessels 80 of FIGS. 6, 7, 7A and 9 are bottles 90, each of which, as shown in FIG. 7, has a main body 92 defining an internal storage cavity 94 and a neck 96 depending from the body 92. The neck 96 is narrow relative to the main body 92 and has a neck opening 98 (or channel) extending therethrough that renders the storage cavity 94 in fluid communication with the exterior of the bottle 90. It will be appreciated that the formation of a relatively narrow neck 96 might best be performed in a multi-stage molding process with at least two physically distinct molds. This is particularly true when the neck 96 and the neck opening 98 must be fabricated within “tight” or relatively unforgiving tolerances, as when the bottles 90 being produced are to be sealed by standardized closures such as caps or plugs (not shown).

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A method of fabricating a decoratively-cracked glass vessel comprising the steps of:
gathering a molten-glass gob;
introducing the molten-glass gob into a pre-form mold;
injecting a quantity of gas into the pre-form mold in order to form the gob into a pre-form vessel having at least one pre-form vessel wall defining a pre-form vessel exterior surface and a pre-form vessel interior surface defining a pre-form vessel cavity;
removing the pre-form vessel from the pre-form mold;
exposing a surface of the pre-form vessel to a fluid that is sufficiently cool relative to the pre-form vessel that cracks are formed along the surface exposed to the fluid;
introducing the pre-form vessel into a finish mold; and
injecting a quantity of gas into the pre-form vessel cavity within the finish mold in order to form the pre-form vessel into a finished vessel having at least one finished vessel wall defining finished vessel interior and exterior surfaces between which cracks are visible.

2. The method of claim 1 wherein at least the finish mold is configured to define a neck portion with a neck opening in the finished vessel.

3. The method of claim 1 wherein the finished vessel is a bottle having a main body defining an internal storage cavity and a neck depending from the body, the neck being narrow relative to the main body and having an opening extending therethrough that renders the storage cavity in fluid communication with the exterior of the bottle.

4. The method of claim 3 wherein the surface of the pre-form vessel that is exposed to a fluid in order to introduce cracks into that surface is the pre-form vessel exterior surface.

5. The method of claim 4 wherein the fluid to which the pre-form vessel exterior surface is exposed is a liquid.

6. The method of claim 5 wherein the liquid is water.

7. The method of claim 1 further comprising reheating the pre-form vessel after the formation of cracks, and prior to introduction into the finish mold, such that at least one of (i) cracks are sealed on the pre-form vessel exterior surface and (ii) the pre-form vessel can be shaped into a finished vessel in the finish mold.

8. A method of fabricating a decoratively-cracked glass vessel comprising the steps of:
depositing a molten-glass gob into a pre-form mold;
injecting a gas into the pre-form mold in order to form the gob into a pre-form vessel having at least one pre-form vessel wall defining a pre-form vessel exterior surface and a pre-form vessel interior surface defining a pre-form vessel cavity;
removing the pre-form vessel from the pre-form mold;
exposing the pre-form vessel exterior surface, while the pre-form vessel is still heated, to a fluid that is sufficiently cool relative to the pre-form vessel that cracks are formed along the pre-form vessel exterior surface;
introducing the cracked and heated pre-form vessel into a finish mold;
injecting a gas into the pre-form vessel cavity within the finish mold in order to (i) form the pre-form vessel into a finished vessel having at least one vessel wall defining vessel interior and exterior surfaces and (ii) promote sealing of cracked areas from within the vessel.

9. The method of claim 8 further comprising heating the finished vessel, after removal from the finish mold, in order to seal the cracks on the finished vessel exterior surface while not re-melting the glass and deforming the finished vessel shape.

10. The method of claim 8 wherein the pre-form mold and finish mold are physically distinct molds used to impart to the vessel, respectively, non-final and final shapes that are perceptibly distinct from one another.

11. A method of decoratively-cracking a glass vessel having a vessel wall defining a vessel exterior surface and a vessel interior surface defining a vessel cavity, the method comprising the steps of:
exposing the vessel exterior surface, while the vessel is heated, to a fluid that is sufficiently cool relative to the vessel that cracks are formed along the vessel exterior surface;
introducing the cracked and heated vessel into a finish mold; and
injecting pressurized gas into the vessel cavity, while the cracked vessel is in the finish mold, in order to promote sealing of cracked areas from within the vessel cavity.

12. The method of claim 11 wherein the finish mold defines a finish-shaping cavity corresponding to the configuration of the heated vessel introduced into the finish mold such that injecting pressured gas into the vessel cavity does not change the basic shape of the vessel.

13. The method of claim 12 further comprising heating the vessel, after removal from the finish mold, in order to further seal the cracks on the vessel exterior surface.

14. The method of claim 11 wherein the finish mold defines a finish-shaping cavity that, in addition to promoting the sealing of cracked areas from within the vessel cavity, imparts the final shape to the vessel when pressured gas is injected into the vessel cavity.

15. The method of claim 14 further comprising heating the vessel, after removal from the finish mold, in order to further seal the cracks on the vessel exterior surface.
